(19) United States
(12) Patent Application Publication
(10) Pub. No.: US 2008/0262888 A1
(43) Pub. Date: Oct. 23, 2008

(54) Method and system for analytical recruitment

(75) Inventors: Sara Molly Robbins, Atlanta, GA (US); Kurt Michael Ronn, Marietta, GA (US)

Correspondence Address: KING & SPALDING LLP, 1180 PEACHTREE STREET, ATLANTA, GA, 30309-3521, US

(73) Assignee: HRworks LLC., Atlanta, GA (US)

(21) Appl. No.: 12/148,753

(22) Filed: Apr. 21, 2008

Related U.S. Application Data
(60) Provisional application No. 60/925,456, filed on Apr. 20, 2007.

(51) Int. Cl. G06Q 10/00

(52) U.S. Cl. 705/7

(57) ABSTRACT

Analytical recruitment by tracking stage, disposition, and time. A recruitment module tracks a stage and disposition of a candidate for a recruitment project as the candidate proceeds through the hiring process. Stages are sequential parts of the recruitment process and dispositions indicate the status of the candidate within the stages. The recruitment module also tracks time spent by recruiters in the recruitment process, by recruitment project and by the type of activity performed. Tracking of this level of detail of time, stage, and disposition provides accuracy in status reporting and recruitment project management. Reports can be generated to reflect various metrics important to the recruitment process, including the hours per candidate presented to the client, and a current status of a project compared to the goal. Finally, data can be stored and tracked for use in invoicing, payroll, forecasting, and other analysis.

### RELATED PATENT APPLICATIONS

This non-provisional patent application claims priority under 35 U.S.C. §119 to U.S. Provisional Patent Application No. 60/925,456, titled “Analytical Recruitment Method Based on Time, Stage, and Disposition Information,” filed Apr. 20, 2007. This provisional application is hereby fully incorporated herein by reference.

### TECHNICAL FIELD

This invention relates to systems and methods for analytical recruiting based on time, stage, and disposition information. More particularly, this invention relates to processes and systems that allow for tracking and recording of time spent by recruiters at each step of the recruitment process, while accurately tracking the status of candidates throughout the recruitment process.

### BACKGROUND

For many companies and industries, employee recruitment is an on-going, time-consuming, yet important task. A desire exists to obtain the right individuals for the right position, while not expending a large amount of resources, in terms of time and expense, in recruiting candidates. Recruitment firms can provide a resource to such companies and industries, by managing the recruitment process. Such firms can help companies by identifying potential candidates, screening those candidates, and presenting certain candidates to a company.

The conventional recruitment process for such firms involves identifying a large pool of candidates that could potentially fill open positions within the company. Then, a recruiter would eventually screen this pool of candidates to determine their suitability to the position(s). Following further qualification, certain candidates would be presented to the hiring company. In other words, the candidates proceed through a “pipeline,” during which the pool of candidates becomes smaller and smaller. The process can vary from firm to firm, but generally involves identifying an initial pool of candidates through a variety of sources; reviewing resumes; contacting the candidate; conducting telephone interviews; obtaining a manager approval; and presenting the candidate to the client to make a hiring decision.

In this conventional process, as a candidate moves through the process, or “pipeline,” the recruiter would make a note regarding which step of the process the candidate was in, for example, screening, approved, hired, etc. However, the notes are not standardized, centralized, or easily accessible to a manager. Accordingly, at any given time in the recruitment process, the status of a recruitment project for a particular company would not be readily available without manually compiling the recruiters' notes. In addition, due to the lack of standardization and centralization, it is not possible to ensure that the snapshot of the recruitment project status was even accurate. Thus, conventional systems do not provide the company with timely, accurate feedback of where the project stood, nor when they would be able to fill their open positions.

Additionally, conventional systems do not allow for precise time-keeping of those associated with the recruitment process, including recruiters and the like, and managers. Companies are generally invoiced by the recruiting firm based on the number of candidates actually hired. Thus, conventional systems provide for invoicing based on the total number of candidates hired by the company. In conventional systems, recruiters and managers do not track their time on an hourly basis by company. These conventional systems do not provide visibility as to the time spent at each step of the recruiting process. Accordingly, the conventional system does not provide a means to predict costs for completion of the project, as the costs do not reflect the stage in the recruitment process, and the amount of remaining work. And, it is not possible to compare current costs to the goal costs. For invoicing purposes, this conventional method can present difficulties in generating accurate invoices to reflect current costs. In addition, it makes forecasting the costs of recruiting unpredictable.

Thus, a need exists in the art for tracking of candidates and time-keeping of recruiters and the like.

### SUMMARY

The invention supports systems and methods for analytical recruitment based on time, stage, and disposition information. A “stage” is used herein to refer to a particular part of the recruitment process. The “disposition” of a candidate is used herein to describe the candidate's status with regard to the stages of the recruiting process. Specifically, the invention can provide systems and methods for accurately tracking candidates through the recruitment process, based on their stage in the process and their disposition, while tracking and recording time spent by those involved in the recruitment process, such as managers and recruiters. The time spent is tracked based on the activity performed by the recruiter and is associated with a particular recruitment project. Accordingly, the invention can provide for an analytical recruitment process with visibility as to the detail of each recruitment project, in terms of the project status, in other words, how many candidates are in a particular stage of the recruitment process and their disposition, and budgeting, in other words, how many hours have been spent by recruiters and others at a particular point in time. The invention therefore can provide the ability to precisely track various aspects of a recruitment project by capturing detailed information. Such information has many useful purposes, for example, forecasting, benchmarking, accurate invoicing, and sales. For example, the invention can provide the ability to calculate the number of hours per interested and qualified candidate (“Hrs/IQ”). This important metric equals the total number of hours spent for a particular recruitment project, divided by the total number of candidates that are interested and qualified, and thus presented, to the client for consideration and interviewing. The Hrs/IQ metric can provide important insight into a project and can provide a significant resource in forecasting future projects. However, this feature is just one example of the many types of reports, metrics, and tables that the invention can support.

In one aspect of the invention, a method for analytical recruitment can include the step of creating a project book that includes multiple candidates for a particular recruitment project. The method also can include managing the candidates in the project book through a recruitment process made up of various stages. A disposition of each candidate is tracked at each stage of the recruitment process, indicating the status of the candidate, such as the candidate's interest level, qualification, and/or availability. A determination is made whether the candidate is interested and qualified for the position associated with the recruitment project. If they are interested and qualified, the candidate is presented to the hiring entity. The method also includes recording the amount of time spent by a recruiter and/or managers who performed recruitment activities at each stages of the recruitment process. Recording time includes creating a time entry that indicates the time spent with regard to the particular recruitment project, and an associated service type, the service type being customizable by client and indicating the type of activity performed. The time entries are stored, and the method can provide for calculation of a metric equal to the total number of hours divided by the total number of candidates presented to the hiring entity. The data stored can be used for creating charts, graphs, tables, and other metrics associated with the amount of time spent in the recruitment process, and for use in invoicing, sales, benchmarking, status reporting, and forecasting.

In another aspect of the invention, a system for analytical recruitment can include a recruitment module that is configured to store and update information associated with candidates. The information includes the stage and disposition associated with each candidate. The recruitment module also can be configured to generate reports based on time entries and candidate information. The system also can include a workstation that is logically connected to the recruitment module and is configured to display candidate information and reports. The workstation further can be configured to receive the time entries that represent an amount of time spent by a recruiter performing recruitment activities associated with each stage of a candidate. The system also can include internal and external applicant tracking systems, to which the recruitment module is logically connected, to exchange data. Finally, the system can include a recruitment database that is logically connected to the recruitment module and is configured to store the time entries and other information for use in invoicing, sales, benchmarking, status reporting, and forecasting in relation to the recruitment process.

In yet another aspect of the invention, a method for analytical recruitment can include managing a candidate through the recruitment process, where the recruitment process includes multiple stages. The disposition of the candidate can be tracked at each stage of the recruitment process. In addition, the method can provide for recording and storing of the amount of time spent by recruiters performing recruitment activities at each of the stages of the recruitment process. Finally, the method can provide for reporting of metrics associated with the amount of time spent performing recruitment activities at each of the stages of the recruitment process, for use in invoicing, sales, benchmarking, status reporting, and forecasting.

These and other aspects, objects, features, and advantages of the invention will become apparent to a person having ordinary skill in the art upon consideration of the following detailed description of exemplary embodiments.

### BRIEF DESCRIPTION OF THE DRAWINGS

FIG. 1 is a block diagram depicting system architecture for analytical recruitment, in accordance with an exemplary embodiment of the present invention.

FIG. 2 is a flow chart depicting an overall method for analytical recruitment, in accordance with an exemplary embodiment of the present invention.

FIG. 3 is a flow chart depicting a method for managing analytical recruitment, in accordance with an exemplary embodiment of the present invention.

FIG. 4 is a flow chart depicting an overall method for recruiting, in accordance with an exemplary embodiment of the present invention.

FIG. 5 is a flow chart depicting a method for building a project book, in accordance with an exemplary embodiment of the present invention.

FIG. 6 is a flow chart depicting a method for pre-qualifying a candidate, in accordance with an exemplary embodiment of the present invention.

FIG. 7 is a flow chart depicting a method for qualifying a candidate, in accordance with an exemplary embodiment of the present invention.

FIG. 8 is a flow chart depicting a method for conducting a manager review of a candidate, in accordance with an exemplary embodiment of the present invention.

FIG. 9 is a flow chart depicting a method for interviewing a candidate, in accordance with an exemplary embodiment of the present invention.

FIG. 10 is a flow chart depicting a method for extending an offer to a candidate, in accordance with an exemplary embodiment of the present invention.

FIG. 11 is a flow chart depicting a method for hiring a candidate, in accordance with an exemplary embodiment of the present invention.

FIG. 12 is a flow chart depicting a method for tracking time, in accordance with an exemplary embodiment of the present invention.

FIG. 13 is a flow chart depicting a method for generating reports, in accordance with an exemplary embodiment of the present invention FIG. 14 is a screenshot depicting a representative report, in accordance with an exemplary embodiment of the present invention.

### DETAILED DESCRIPTION OF THE EXEMPLARY EMBODIMENTS

The invention is directed to analytical recruitment by tracking time, stage, and disposition information. A recruitment module tracks a stage and disposition of a candidate for a recruitment project as the candidate proceeds through the hiring process. Stages are sequential parts of the recruitment process and dispositions indicate the status of the candidate within the stage. The recruitment module also tracks time spent by recruiters in the recruitment process, by recruitment project and by the type of activity performed. Tracking of this level of detail of time, stage, and disposition provides for accuracy in status reporting and recruitment project management. Reports can be generated to reflect various metrics important to the recruitment process, including the hours per candidate presented to the client and a current status of a project compared to the goal. Finally, data can be stored and tracked for use in invoicing, payroll, forecasting, and other analysis.

The invention includes a computer program that embodies the functions described herein and illustrated in the appended flow charts. However, it should be apparent that there could be many different ways of implementing the invention in computer programming, and the invention should not be construed as limited to any one set of computer program instructions. Further, a programmer having ordinary skill in the art would be able to write such a computer program to implement an embodiment of the disclosed invention based on the flow charts and associated description in the application text. Therefore, disclosure of a particular set of program code instructions is not necessary for an adequate understanding of how to make and use the invention. The inventive functionality of the claimed computer program will be explained in more detail in the following description read in conjunction with the figures illustrating the program flow.

Turning now to the drawings, in which like numerals indicate like elements throughout the figures, exemplary embodiments of the invention are described in detail.

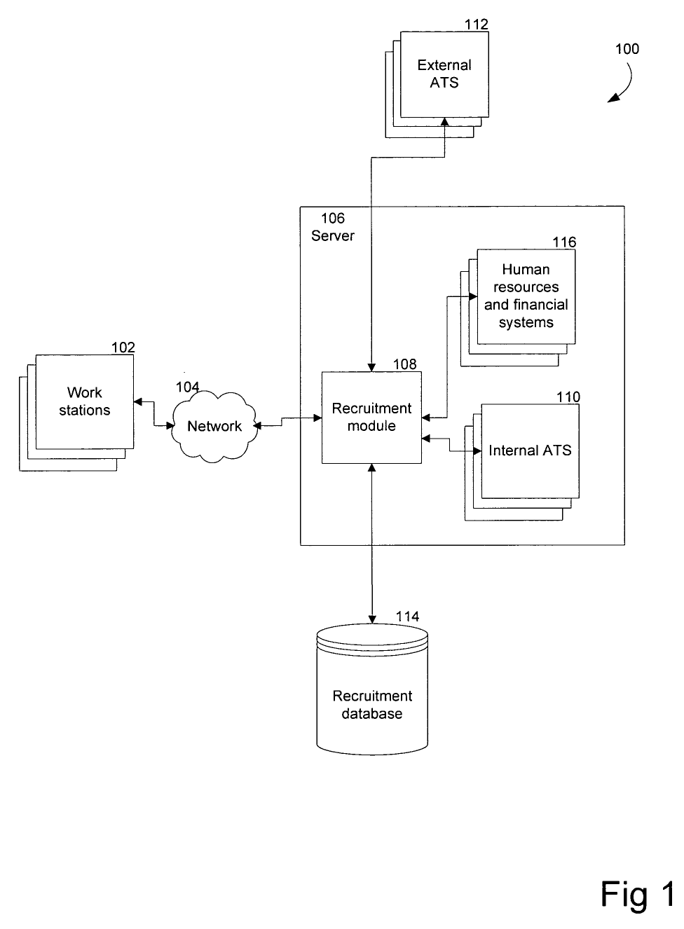

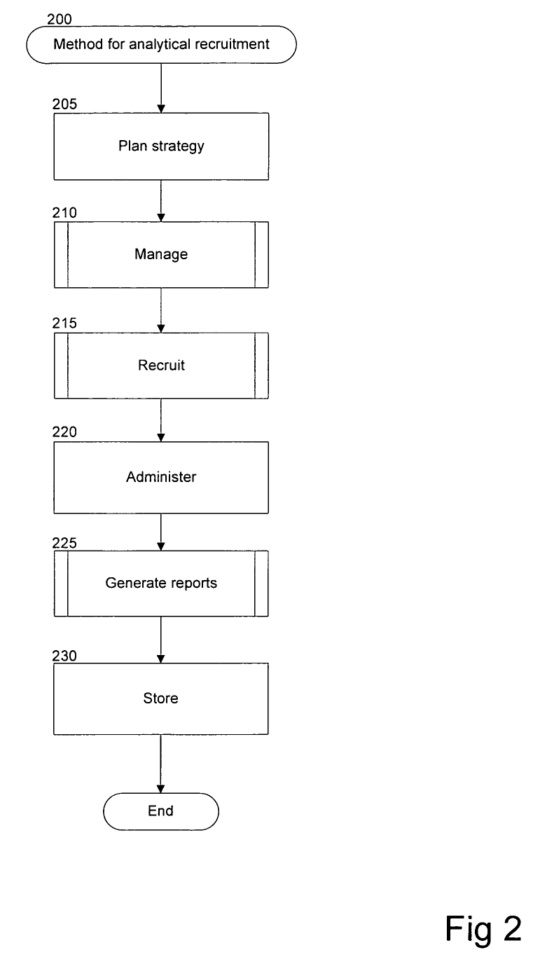

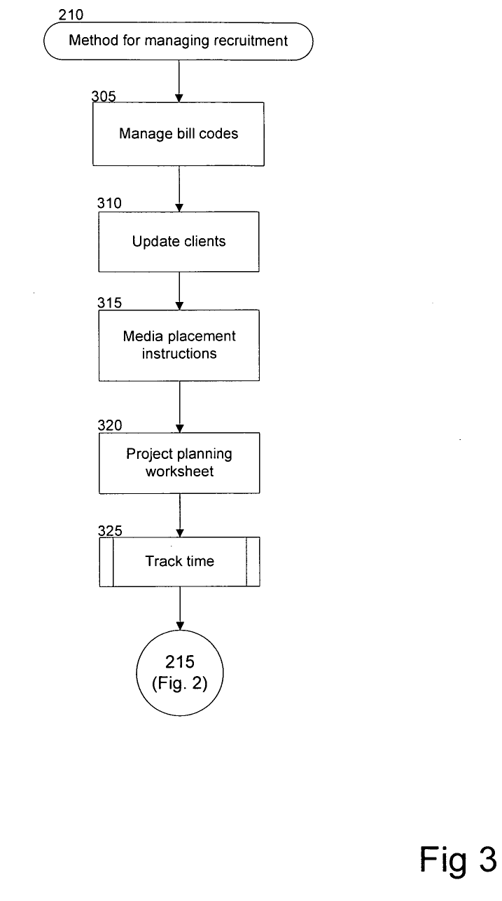

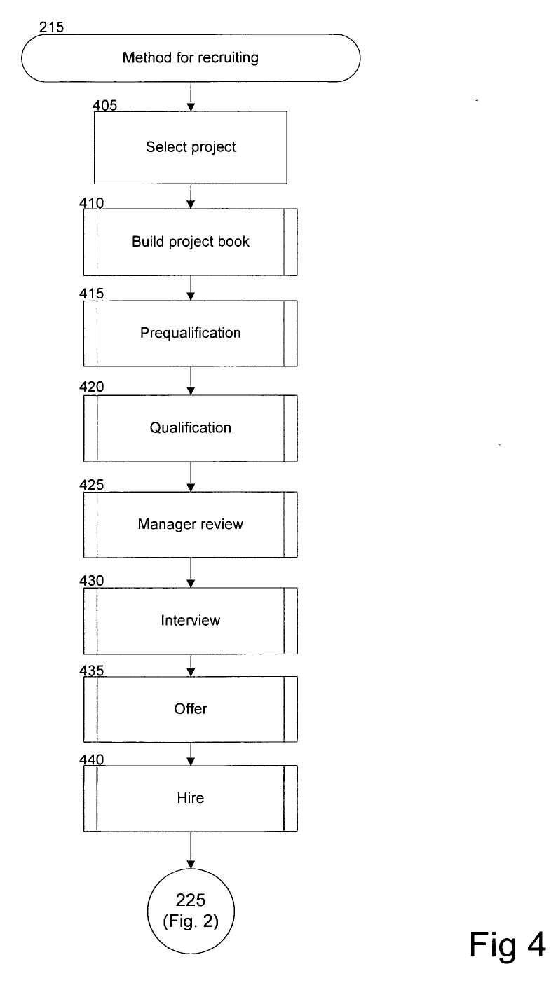

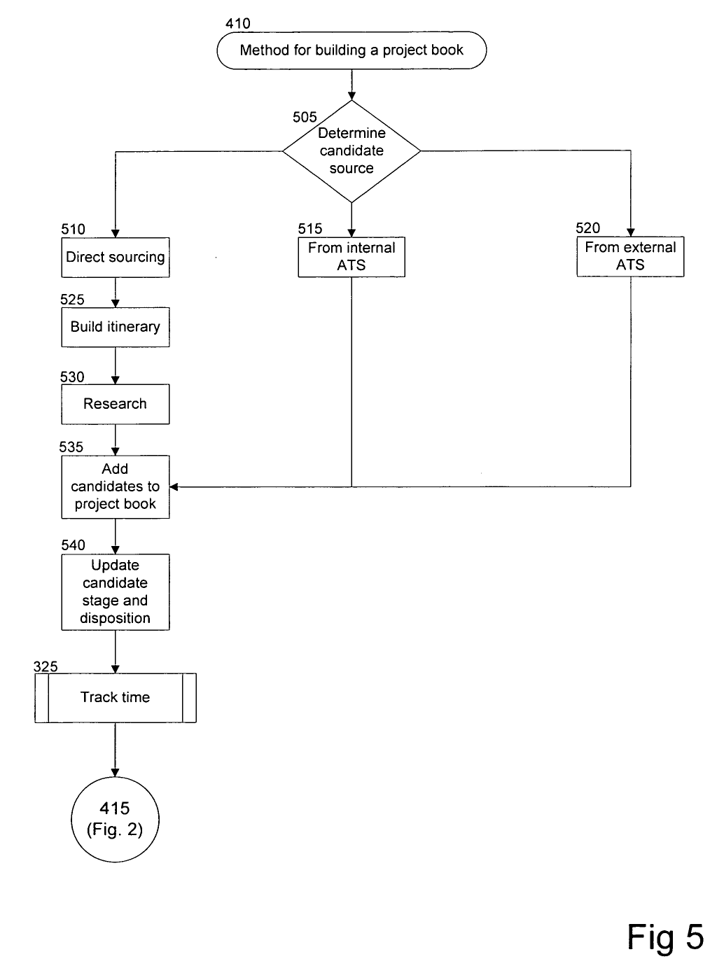

FIG. 1 is a block diagram depicting a system 100 for analytical recruitment, in accordance with certain exemplary embodiments of the invention. The system 100 is described hereinafter with reference to the methods illustrated in FIGS. 2-13.

FIG. 2 is a flow chart depicting an overall method 200 for analytical recruitment, in accordance with an exemplary embodiment of the present invention. The exemplary method 200 is illustrative and, in alternative embodiments of the invention, certain steps can be performed in a different order, in parallel with one another, or omitted entirely, and/or certain additional steps can be performed without departing from the scope and spirit of the invention. The method 200 is described hereinafter with reference to FIGS. 1 and 2.

In step 205, a manager plans a strategy for a recruitment project for a particular client. The manager is a member of a recruitment firm. “Recruitment firm” or “firm” is used herein to refer to the entity managing the recruitment of candidates for one or more clients. The manager reviews the goals with the client to determine expectations, costs, and structure of the recruitment process. “Client” is used herein to refer to the entity hiring the recruitment firm to recruit candidates for the client's review and eventual hiring. In an alternative embodiment, the client and the firm can be the same entity. In this embodiment, the client would use the systems and methods described herein as used by the firm but for internal hiring. In this step, a recruitment strategy is planned, which includes the number of positions to be filled, the source of the candidate, and/or client-specific steps pertaining to the recruitment process.

In step 210, the manager manages the recruitment process. The manager can use a workstation 102 to access a recruitment module 108, via a network 104. The recruitment module 108 is an application, located on a server 106, that performs the functionality for tracking candidates through the recruitment process and for tracking time spent during the recruitment process. Step 210 will be described in more detail hereinafter with reference to FIG. 3.

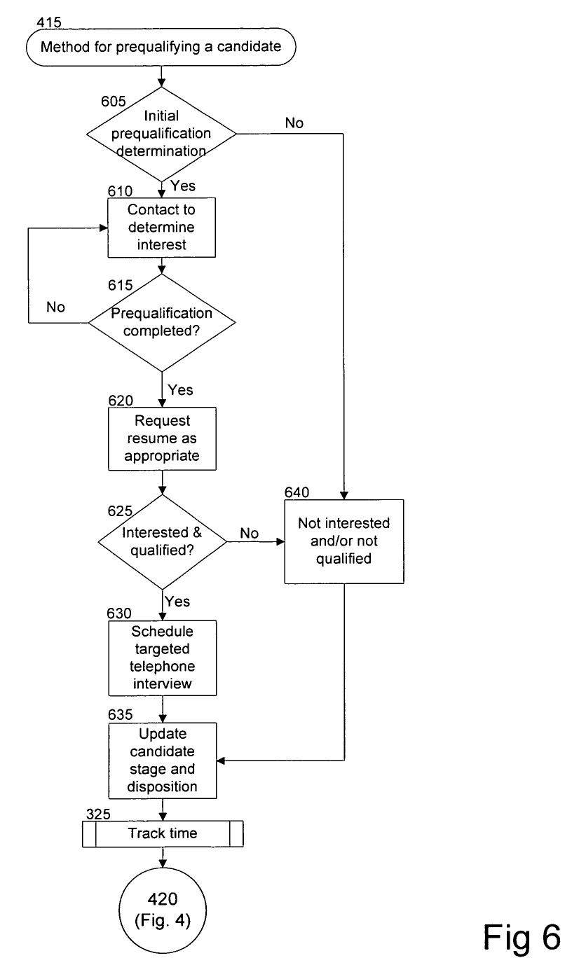

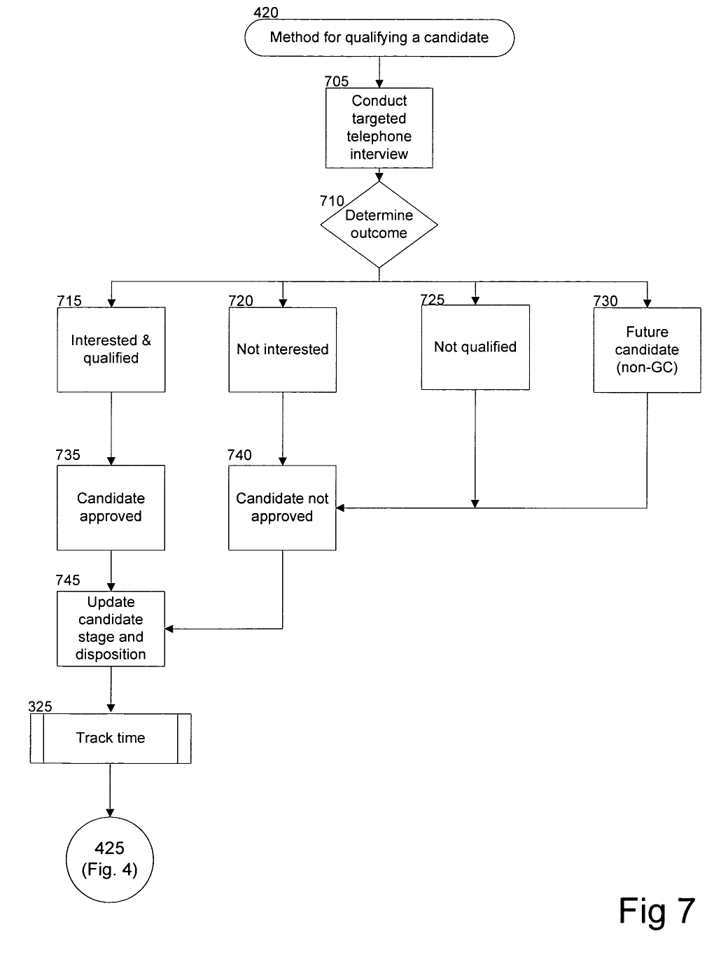

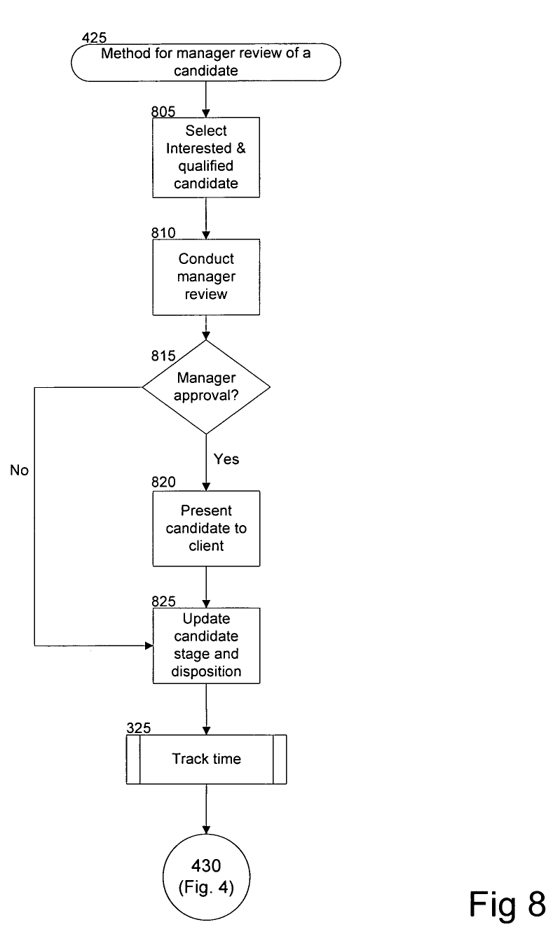

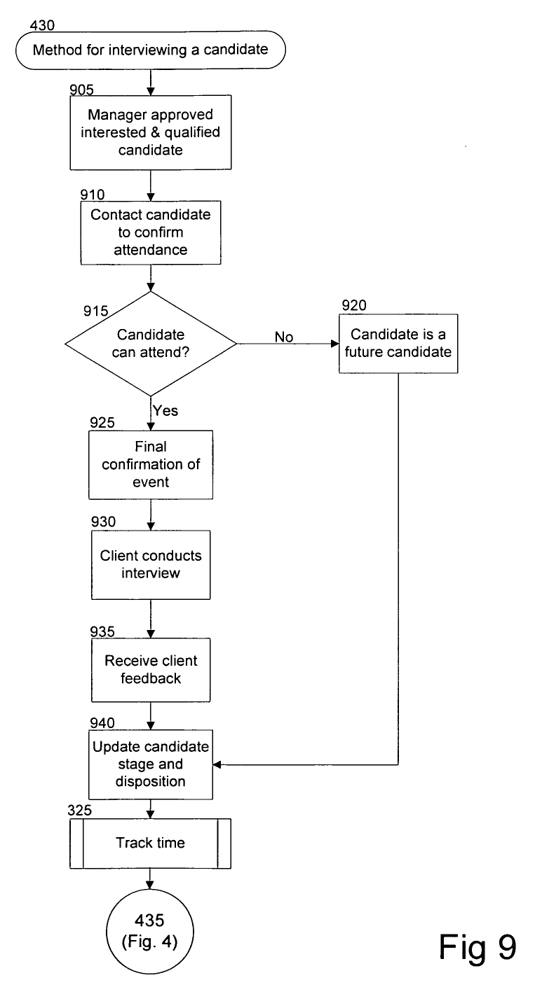

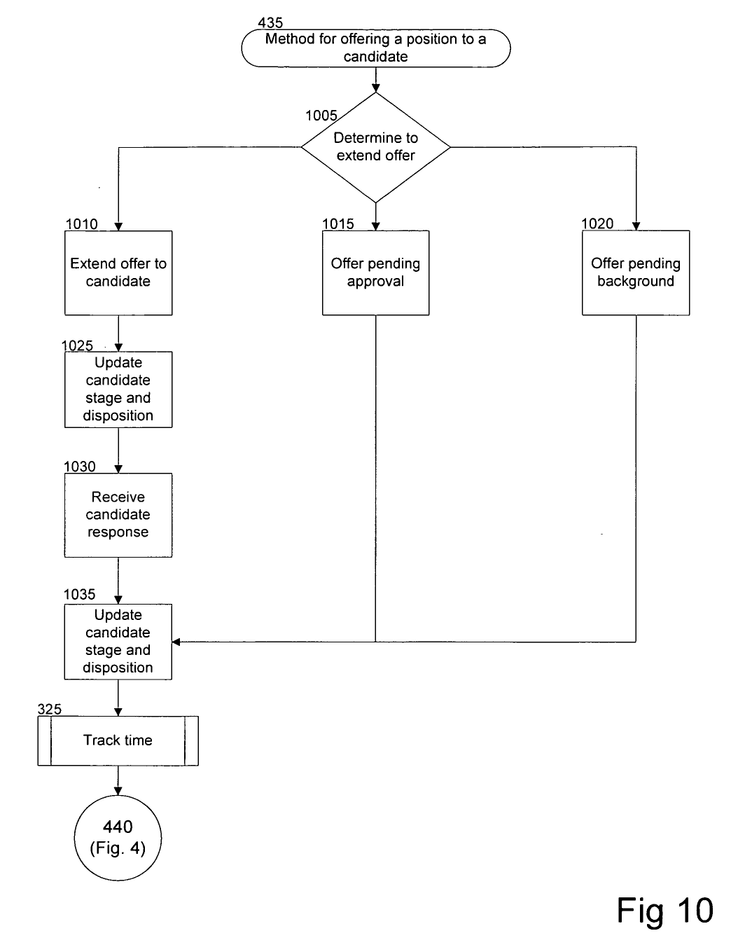

In step 215, a recruiter performs the functions of the recruitment process. Step 215 will be described in more detail hereinafter with reference to FIGS. 4-12.

In step 220, an administrator performs administration within the recruitment module 108 and/or recruitment database 114. An administrator can access the recruitment module 108 over the network 104 by using the workstation 102. An administrator can also manage the interface between the recruitment module 108 and the recruitment database 114, the external applicant tracking system (“ATS”) 112, human resources and financial systems 116, and an internal ATS 110. Such administration steps can include, for example, establishing an interface with one or more internal human resources and financial systems 116, and providing for invoicing adjustments. Accordingly, the system can provide for accurate and timely invoicing. In addition, an administrator can provide for importing candidates from an ATS. An ATS is a system used to store candidate information and can be populated by various means. For example, it can be populated from an applicant recruiting website. In an exemplary embodiment, the recruitment module 108 can interface with one or more internal ATS 110 and/or one or more external ATS 112. An internal ATS 110 is an applicant tracking system located on the same server 106 as the recruitment module 108, and an external ATS 112 is located outside of the server 106.

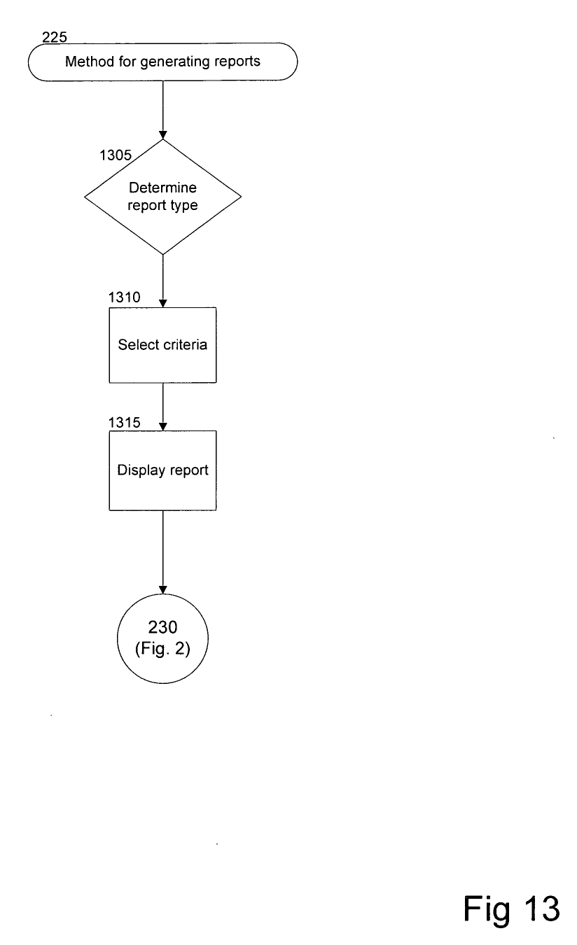

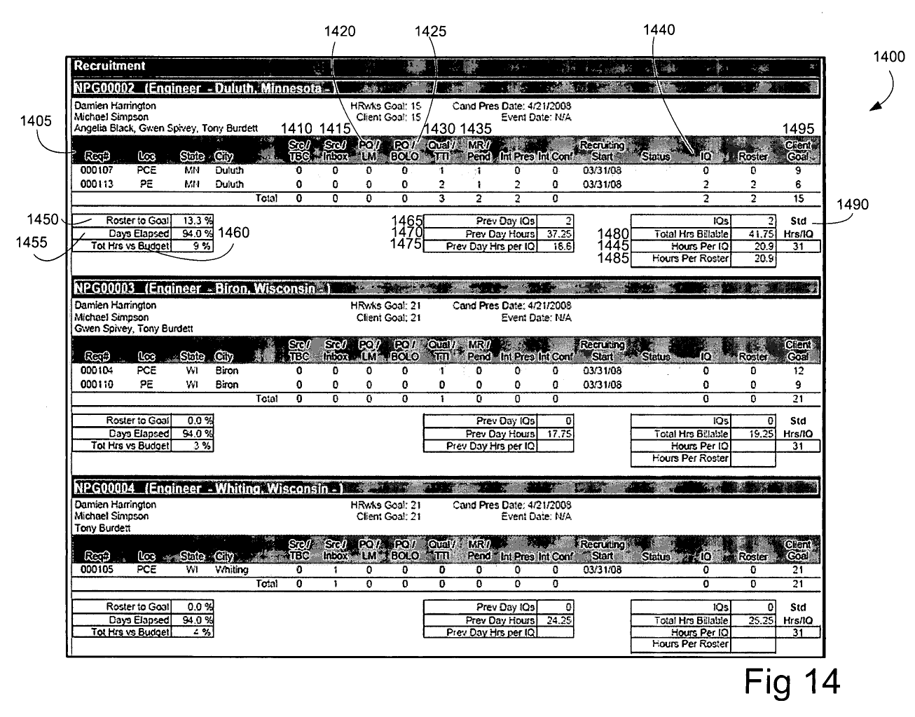

In step 225, users of the recruitment module 108, including administrators, managers, and recruiters, can generate reports. Step 225 will be described in more detail hereinafter with reference to FIG. 13.

In step 230, the recruitment database 114 stores information related to the recruitment process. An administrator can manage the frequency and content of the information stored in the recruitment database 114.

FIG. 3 is a flow chart depicting a method 210 for managing analytical recruitment, in accordance with an exemplary embodiment of the present invention. The exemplary method 210 is illustrative and, in alternative embodiments of the invention, certain steps can be performed in a different order, in parallel with one another, or omitted entirely, and/or certain additional steps can be performed without departing from the scope and spirit of the invention. The method 210 is described hereinafter with reference to FIGS. 1 and 2.

In step 305, a manager can manage bill codes. As stated above, the manager can access the recruitment module 108 by using the workstation 102 over the network 104. A bill code is a code that identifies a particular recruitment project for a particular client. In an exemplary embodiment, the bill code comprises a three character string particular to the client, followed by a five digit number sequentially assigned by the recruitment module 108 and particular to the recruitment project. Accordingly, each bill code is associated only with one particular client, and, as described below with reference to FIG. 4, one project book. As used herein, the term “bill code” will be used to describe a particular recruitment project, and the terms “bill code” and “recruitment project” or “project” will be used interchangeably herein. Also in step 305, a manager can assign recruiters to a particular recruitment project. The actual recruitment process will be described hereinafter with reference to FIGS. 4-12.

In step 310, a manager can update the list of clients in the recruitment module 108. For example, the manager can change attributes of existing clients, and/or add new clients.

At step 315, a manager can create tasks for media placement specialists. The media placement specialist's role is to identify and price potential sources to post positions. Positions can be posted, for example, on job boards and/or through associations. Once approved, media placement specialist posts job postings, updates the assigned tasks, and enters time associated with the task. A media placement specialist's time can be entered as described herein with reference to FIG. 12.

At step 320, a manager can plan a project. In this step, the manager can determine resources needed for a given recruitment project. In this step, a manager can base the resource level on historical data, provided by the storing and reporting capabilities of the recruitment module 108. For example, for similar projects, a manager can review the number of recruiters needed in the prior project, to more accurately predict the number of recruiters needed for a current project. Reporting will be described in more detail herein with reference to FIG. 13.

In step 325, the manager tracks the time spent in the stage of managing recruitment, or, in other words, the time spent performing each of steps 305 through 325. Step 325 will be described in more detail herein with reference to FIG. 12. The method 210 proceeds to step 215 of FIG. 2.

FIG. 4 is a flow chart depicting a method 215 for recruiting, in accordance with an exemplary embodiment of the present invention. The exemplary method 215 is illustrative and, in alternative embodiments of the invention, certain steps can be performed in a different order, in parallel with one another, or omitted entirely, and/or certain additional steps can be performed without departing from the scope and spirit of the invention. The method 215 is described hereinafter with reference to FIGS. 1-12.

In step 405, the recruiter selects a particular project. In an exemplary embodiment, the recruiter is assigned to a particular project by a manager, as described herein with reference to FIG. 3. The recruiter can be an employee of a recruitment firm assigned to a particular recruitment project The recruiter can perform the steps of the method 220 by using the workstation 102 to access the recruitment module 108 over the network 104.

In step 410, the recruiter builds a project book. The recruiter can access the recruitment module 108 over the network 104 using the workstation 102. The recruitment module interfaces with the external ATS 112 and the internal ATS 110 in building the project book. The project book is specific to a particular recruitment project. Building the project book is a stage in the analytical recruitment process. A “stage” is used herein to refer to a particular part of the recruitment process. In this exemplary embodiment, stages include: building a project book, prequalification, qualification, manager review, interview, offer, and hire. Generally speaking, the stages are sequential and chronological, i.e. a candidate must proceed through all preceding stages before entering the next stage. For example, a candidate must be entered in the project book, prequalified, and qualified, before entering the stage for manager review. The various stages will be described in more detail herein with reference to FIGS. 6-11. Step 410 will be described in more detail hereinafter with reference to FIG. 5.

In step 415, the recruiter pre-qualifies candidates in the project book. Pre-qualification is a stage in the analytical recruitment process. Step 415 is described in more detail hereinafter with reference to FIG. 6.

In step 420, the recruiter and/or the manager qualifies candidates that were pre-qualified in step 415. Qualification is yet another stage in the analytical recruitment process. Step 420 is described in more detail hereinafter with reference to FIG. 7.

In step 425, the manager performs a review of candidates qualified in step 420, manager review being yet another stage in the analytical recruitment process. Step 425 is described in more detail hereinafter with reference to FIG. 8.

In step 430, the candidate, approved by the manager in step 420, is presented to and interviewed by the client. Entrance into this stage indicates that the candidate is both interested and qualified, as determined by both the recruiter and manager. The interview is another stage in the analytical recruitment process. Step 430 is described in more detail below herein with reference to FIG. 9.

In step 435, the client, the recruiter, and/or the manager extend an offer to a candidate successfully interviewed in step 430, the offer being a stage in the analytical recruitment process. Step 435 is described in more detail hereinafter with reference to FIG. 10.

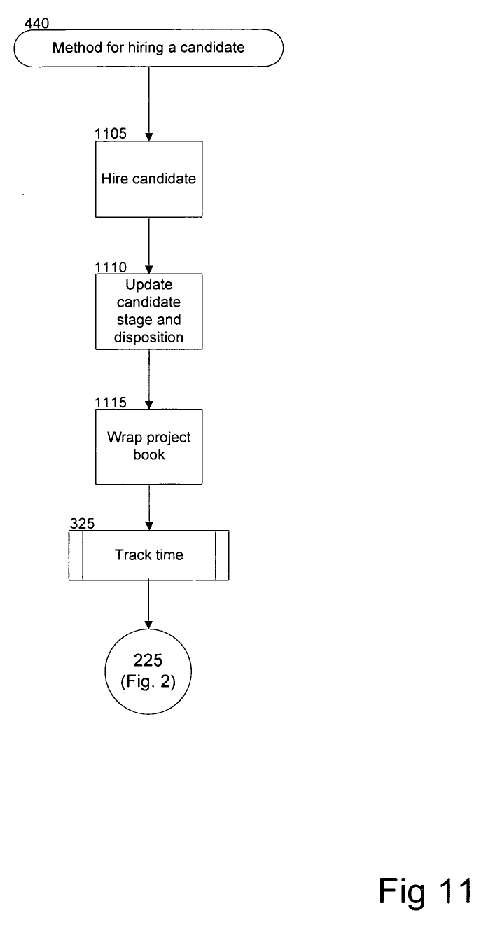

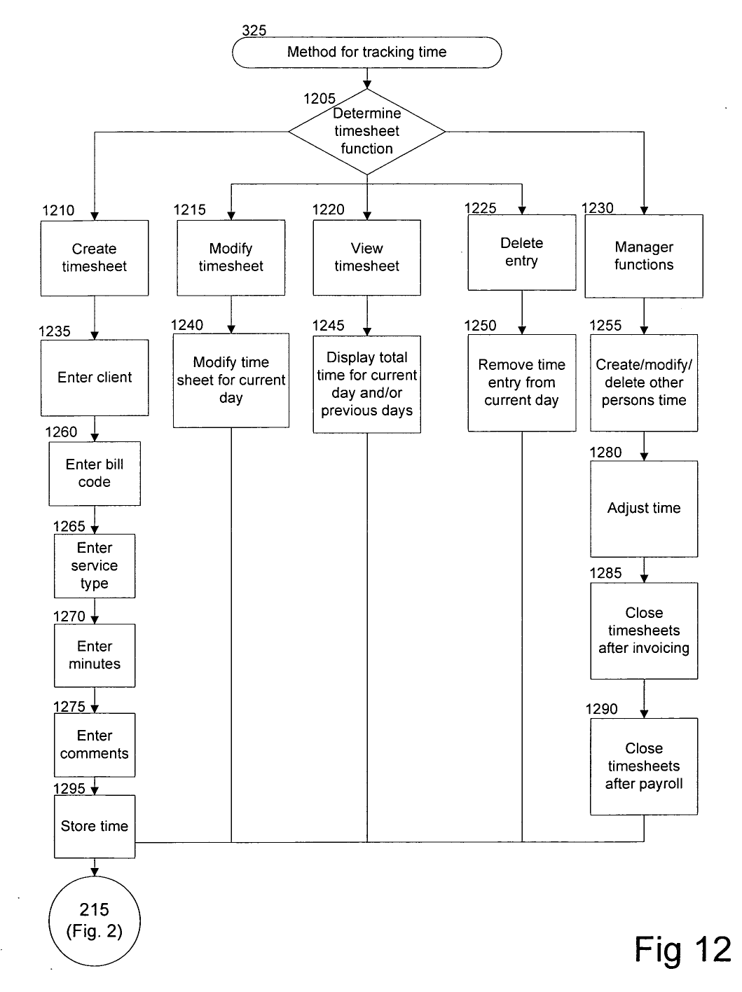

In step 440, the candidate, who accepted an offer in step 435, is hired by the client. Hiring is the final stage in the analytical recruitment process. Step 440 is described in more detail hereinafter with reference to FIG. 11.

FIG. 5 is a flow chart depicting a method 410 for building a project book, in accordance with an exemplary embodiment of the present invention. The exemplary method 410 is illustrative and, in alternative embodiments of the invention, certain steps can be performed in a different order, in parallel with one another, or omitted entirely, and/or certain additional steps can be performed without departing from the scope and spirit of the invention. The method 410 is described hereinafter with reference to FIGS. 1, 4 and 12.

In step 505, the recruiter makes a determination of the candidate source. This determination can also be made by a manager during the planning of the recruitment strategy, described herein with reference to step 205 of FIG. 2. If, in step 505, the candidates are to be direct sourced, the method proceeds to step 510, and the method proceeds as described hereinafter. If, in step 505, the candidates are to be sourced from an internal ATS 110, the method proceeds to step 515, and the method proceeds as described hereinafter. If, in step 505, the candidates are to be sourced from an external ATS 112, the method proceeds to step 520, and the method proceeds as described hereinafter.

In step 510, the recruiter sources the candidates directly. By direct sourcing, the recruiter identifies candidates through networking, company knowledge, and other sources, that are not automatically populated into the project book. For example, the recruiter can contact known contacts at certain companies for referrals of potential candidates.

In step 525, the recruiter builds an itinerary. An itinerary is a list of companies that can contain potential candidates.

In step 530, the recruiter researches individuals employed at the company. Researching involves identifying specific individuals within the companies identified in step 425 that are potential candidates.

In step 515, the recruiter sources the candidates from an internal ATS 110. In this step, the recruitment module 108 interfaces with the internal ATS 110 to retrieve candidates that are suitable as candidates for the particular project.

In step 520, the recruiter sources candidates from an external ATS 112. In this step, the recruitment module 108 interfaces with an external ATS 112 to retrieve candidates that are suitable as candidates for the particular project and to enter those candidates into the project book stored in the recruitment database 114. Thus, the project book can be autopopulated with candidates from an external ATS 112. In an exemplary embodiment, the external ATS 112 can include Taleo® and Peopleclick®.

At step 535, the recruiter adds candidates sourced by direct sourcing, an internal ATS 110 and/or an external ATS 112 to the project book. In step 535, the project book thus contains candidates that are potentially suitable to the position(s) particular to the recruitment project.

In step 540, the recruiter updates the stage and disposition of each candidate in the project book. The recruiter accesses the recruitment module 108 over the network 104 by using the workstation 102, to update the candidate's stage and disposition. For example, the recruiter can input the current stage and disposition into the client workstation 102, to update the appropriate fields in the recruitment module 108, which information is stored in the recruitment database 114. A stage has been described previously with reference to FIG. 4. The “disposition” of a candidate is used herein to describe the candidate's status. The status can indicate an interest level, qualification level, availability, recruiter review, manager review, and other indications of the candidate's status, as it pertains to the particular recruitment project. For example, a disposition of “Not Qualified” indicates that the candidate is not qualified for the position. As another example, the disposition “Extended” indicates that an offer has been extended to the candidate. Generally speaking, dispositions are associated with a particular stage in the recruitment process, in other words, a candidate must be in the stage “Offer” to have the disposition of “Extended.”

Table 1.0 below depicts a representative set of candidate stages and dispositions, in accordance with an exemplary embodiment of the present invention. As shown in the chart, at each stage in the recruitment process, the candidate can have various dispositions. Further, under the column “Definition,” the meaning of each disposition is described. The table below is merely representative of exemplary stages and dispositions, and one of ordinary skill in the art having the benefit of this disclosure would recognize that other stages, and dispositions, and definitions can be used without departing from the spirit and scope of the invention.

TABLE 1.0

| Stage | Disposition | Definition |
|---|---|---|
| Build | Research | Company name entered only. |
| Project | | Needs to be researched (get |
| Book/ | | person's name) |
| Sourcing | TBC | Have the persons name and |
| | | they need to be contacted |
| | Inbox | Candidates that have applied |
| | | and pass the questionnaire |
| | LM | Left message (NETWORKING |
| | | in comments) |
| | I | Candidates are Interested in |
| | | the position but may not have |
| | | been able to talk. You must call |
| | | them back or they will call you |
| | | back. |
| | NI | The Candidate is not interested |
| | | in the opportunity |
| | NQ | The Recruiter is not interested |
| | | in the candidate |
| | DNC | Do not contact |
| Pre- | Scheduled | Phone screen on the fly or |
| qualification | (Default) | scheduled phone screen |
| | LM | Recruiter calls or emails the |
| | | candidate |
| | BOLO | Be On the Lookout; waiting for |
| | | candidate to apply to ATS |
| | | (BOLO in comments) |
| | NI | Candidate is not selected after |
| | | paper screen, phone screen, or |
| | | is not interested in moving |
| | | forward; select other |
| | | candidates better qualified |
| | | AND decline email option |
| Qualification | TTI Scheduled | Targeted telephone interview |
| | (Default) | (TTI) has been scheduled |
| | | (candidate is in ATS if |
| | | applicable) |
| | NQ | Candidate is not qualified |
| | NI | Candidate is no longer |
| | | interested in the position |
| | Future | Possible Candidate for future |
| | | opening |
| Manger | Pending | Candidate is interested and |
| Review | | qualified - To be reviewed by |
| | | manager |
| | NQ | Manager Review - Not |
| | | Qualified |
| | Future | Manager Review - Future |
| | | Candidate |
| Interview | Presented | Candidates presented to the |
| (Count | (Default) | client or scheduled to an event |
| Number of | Test Pending | Future Use |
| Interested & | Confirmed | Candidates confirmed to attend |
| Qualified) | | hiring event or interview |
| | Invited | Future Use |
| | Interview A | Future Use |
| | Interview B | Future Use |
| | Test Failed | Future Use |
| | NI (Candidate) | Candidate is no longer |
| | | interested in the position |
| | NQ | Hiring Manager is not |
| | | interested in candidate |
| | Future | Candidate can not attend hiring |
| | | event or interview |
| Offer | Extended | Offer is extended to the |
| | | candidate |
| | Pending Offer | Hiring Manager is interested in |
| | | hiring the candidate |
| | Background | Waiting on candidate's |
| | Pending | background results |
| | Background Failed | Candidate's background results |
| | | failed |
| | Accepted | Candidate accepts the offer |
| | Declined | Candidate declined the offer |
| | Rescinded | Offer is rescinded from the |
| | | candidate |
| Hired | Hired | Hired by the company |

In step 325, the recruiter tracks the time spent in the stage of building the project book, or, in other words, the time spent performing each of steps 505 through 540. Step 325 will be described in more detail herein with reference to FIG. 12. The method proceeds to step 415 of FIG. 4.

FIG. 6 is a flow chart depicting a method 415 for pre-qualifying a candidate, in accordance with an exemplary embodiment of the present invention. The exemplary method 415 is illustrative and, in alternative embodiments of the invention, certain steps can be performed in a different order, in parallel with one another, or omitted entirely, and/or certain additional steps can be performed without departing from the scope and spirit of the invention. The method 415 is described hereinafter with reference to FIGS. 1, 4 and 12.

In step 605, the recruiter makes an initial prequalification determination. In this step, the recruiter, if possible, reviews a candidate's resume, the candidate being a candidate of the project book created in step 410 of FIG. 4. Based on the attributes of the specific recruitment project, the recruiter can make this initial prequalification determination. If, in step 605, the recruiter determines that the candidate is not qualified, the method proceeds to step 640, described hereinafter. If, in step 605, the recruiter determines that the candidate is potentially qualified, the method proceeds to step 610.

In step 610, the recruiter contacts the candidate to determine interest. For example, the recruiter can telephone the candidate and/or email the candidate.

In step 615, the recruiter determines whether the prequalification is completed. The prequalification is completed if the recruiter has determined the interest and qualification of the candidate, to the extent necessary at this stage of prequalification. If, in step 615, the prequalification was not completed, the method returns to step 610, as previously described herein. In this way, the recruiter can again attempt to contact the candidate, if the candidate was unavailable initially in step 610. If, in step 615, the recruiter determines that the prequalification is completed, the method proceeds to step 620.

In step 620, the recruiter requests the candidate's resume, as appropriate. The recruiter may already have access to the candidate's resume, but will request it if not in step 620.

In step 625, the recruiter determines whether the candidate is actually interested and qualified, to the extent necessary in the prequalification stage. If the candidate is interested and qualified, the method proceeds to step 630. If, in step 625, the candidate is not interested and qualified, the method proceeds to step 640, described hereinafter.

In step 630, the recruiter schedules the candidate for a targeted telephone interview (“TTI”). In an exemplary embodiment, the targeted telephone interview is a situational based telephone interview specific to the client needs and competencies required for the recruitment project.

In step 635, the recruiter updates the candidate stage and disposition, as described previously with reference to step 540 of FIG. 5. For example, if the candidate is interested and qualified, and is scheduled for a targeted telephone interview following the prequalification stage, the recruiter will indicate that the candidate's disposition is “TTI Scheduled” and has moved to the “Qualification” stage. Alternatively, if the candidate did not meet the requirements of the prequalification stage, the recruiter will update the candidate's stage to “NI” and the candidate will not move past the “Prequalification” stage.

Referring back to step 640, the recruiter determines that the candidate is not qualified and/or not interested, based on information from step 605 or step 625. The recruiter bases the decision on the background, experience, and other attributes of the candidate, and compares them to the needs of the project. In addition, the recruiter assesses the interest level of the candidate. Upon a determination of the candidate's interest and qualification, the method proceeds to step 635, discussed previously. From step 635, the method proceeds to step 325.

In step 325, the recruiter tracks the time spent in the prequalification stage, or in other words, the time spent performing steps 605 through 635. Step 325 will be described in more detail herein with reference to FIG. 12. The method proceeds to step 420 of FIG. 4.

FIG. 7 is a flow chart depicting a method 420 for qualifying a candidate, in accordance with an exemplary embodiment of the present invention. The exemplary method 420 is illustrative and, in alternative embodiments of the invention, certain steps can be performed in a different order, in parallel with one another, or omitted entirely, and/or certain additional steps can be performed without departing from the scope and spirit of the invention. The method 420 is described hereinafter with reference to FIGS. 1, 4 and 12.

FIG. 7 represents the stage “Qualification.” Actions performed by the recruiter in this stage pertain only to those candidates designated as in this stage, according to their status in the project book.

In step 705, a recruiter conducts a targeted telephone interview with the candidate. The targeted telephone interview was described previously with reference to FIG. 6, In step 710, the recruiter makes a determination regarding the candidate in regard to the results of the targeted telephone interview. If, in step 710, the recruiter determines that the candidate is interested and qualified, the method proceeds to step 715. If, in step 710, the recruiter determines that the candidate is not interested, the method proceeds to step 720. If, in step 710, the recruiter determines that the candidate is not qualified, the method proceeds to step 725. If, in step 710, the recruiter determines that the candidate is a future candidate, the method proceeds to step 730.

In step 715, the candidate is interested and qualified. Interested and qualified is a disposition that indicates that the candidate is interested in the position and qualified for the position, as determined by the recruiter, pending manager review. The method proceeds to step 735, wherein the candidate is approved by a manager. The method then proceeds to step 745, as described hereinafter.

In step 720, the candidate is not interested in the position. The method proceeds to step 740.

In step 725, the candidate is not qualified for the position. The method proceeds to step 740.

In step 730, the candidate is identified as a future candidate. A future candidate indicates that the candidate is not currently suited to the position, but may be in the future. This option is only available for non-government contractors. The method proceeds to step 740.

In step 740, the candidate is not approved.

In step 745, the recruiter updates the candidate stage and disposition, as described previously with reference to step 540 of FIG. 5. For example, if the candidate has met the requirements to be qualified, the recruiter will update the stage to “Manager Review” and the disposition to “Pending.”

In step 325, the recruiter tracks the time spent in the qualification stage, or in other words, the time spent performing steps 705 through 745. Step 325 will be described in more detail herein with reference to FIG. 12. The method proceeds to step 425 of FIG. 4.

FIG. 8 is a flow chart depicting a method 425 for conducting a manager review of a candidate, in accordance with an exemplary embodiment of the present invention. The exemplary method 425 is illustrative and, in alternative embodiments of the invention, certain steps can be performed in a different order, in parallel with one another, or omitted entirely, and/or certain additional steps can be performed without departing from the scope and spirit of the invention. The method 425 is described hereinafter with reference to FIGS. 1, 4 and 12.

FIG. 8 represents the stage “Manager Review.” Actions performed in this stage pertain only to those candidates designated as in the stage Manager Review, according to their status in the project book.

In step 805, a manager selects an interested and qualified candidate from the project book associated with the project.

In step 810, the manager conducts a manager review. The manager review can include a review of the candidate's resume, notes made by the recruiter, notes from a targeted telephone interview, and/or another type of manager review.

In step 815, the manager determines whether the candidate is approved for further consideration. If, in step 815, the manager approves the candidate, the method proceeds to step 820. If, in step 815, the manager does not approve the candidate, the method proceeds directly to step 825. For example, the manager can determine that the candidate is not qualified for the position, or is a future candidate, based on the manager's review.

In step 820, following an approval of the manager in step 815, the candidate is presented to the client. Presentation to the client involves contacting the client with the candidate's information, and informing the client that the candidate is appropriate for interviewing, and/or scheduling an interview with the client.

In step 825, the manager updates the candidate stage and disposition, as described previously with reference to step 540 of FIG. 5. For example, if the candidate was approved by the manager in step 815, and scheduled for an interview in step 810, the manager updates the candidate's disposition to “Presented,” and the candidate's stage to “Interview.” If, on the other hand, the candidate was not approved by the manager in step 815, but was identified as a future candidate, the manager updates the candidate's disposition to “Future,” and the candidate remains in the stage “Manager Review.”

In step 325, the manager tracks the time spent in the manager review stage, or in other words, the time spent performing steps 805 through 825. Step 325 will be described in more detail herein with reference to FIG. 12. The method proceeds to step 430 of FIG. 4.

FIG. 9 is a flow chart depicting a method 430 for interviewing a candidate, in accordance with an exemplary embodiment of the present invention. The exemplary method 430 is illustrative and, in alternative embodiments of the invention, certain steps can be performed in a different order, in parallel with one another, or omitted entirely, and/or certain additional steps can be performed without departing from the scope and spirit of the invention. The method 430 is described hereinafter with reference to FIGS. 1, 4, and 12.

FIG. 9 represents the stage “Interview.” Actions performed in this stage pertain only to those candidates designated as in the stage Interview, according to their status in the project book. Accordingly, for example, only candidates that are interested and qualified and approved by a manger in step 815 of FIG. 8 are eligible to be in the Interview stage.

In step 905, an interested and qualified candidate, who has been approved by a manager, is selected from the project book.

In step 910, a recruiter, manager, and/or the client contacts the candidate to confirm attendance at the interview. If an interview has not already been scheduled, then the recruiter, manager, and/or client will contact the client and schedule the interview in step 910.

In step 915, a determination is made whether the candidate can attend the interview. For example, the client and/or the candidate may have a change in schedule or interest, and may not be able to make the interview. If, in step 915, the determination is made that the candidate cannot attend the event, the method proceeds to step 920. In step 920, the candidate is labeled a future candidate, and the method proceeds to step 940, as described in more detail hereinafter.

Referring back to step 915, if the determination is made that the candidate can attend the interview, the method proceeds to step 925.

In step 925, upon a determination that the candidate can attend the interview, the recruiter, manager, and/or recruiter makes a final confirmation of the interview.

In step 930, the client conducts the interview.

In step 935, the recruiter receives feedback from the client regarding the interview. For example, the client may indicate whether the client wants to hire the candidate, would like a further interview, and/or has decided not to hire the candidate.

In step 940, the recruiter updates the candidate stage and disposition, as described previously with reference to step 540 of FIG. 5. For example, if the client was not interested in the candidate after the interview, the recruiter updates the candidate's disposition to “NQ” (not qualified) and maintains the candidate's stage as “Interview.”

In step 325, the recruiter tracks the time spent in the interview stage, or in other words, the time spent performing steps 905 through 940. Step 325 will be described in more detail herein with reference to FIG. 12. The method proceeds to step 435 of FIG. 4.

FIG. 10 is a flow chart depicting a method 435 for extending an offer to a candidate, in accordance with an exemplary embodiment of the present invention. The exemplary method 435 is illustrative and, in alternative embodiments of the invention, certain steps can be performed in a different order, in parallel with one another, or omitted entirely, and/or certain additional steps can be performed without departing from the scope and spirit of the invention. The method 435 is described hereinafter with reference to FIGS. 1, 4, and 12.

FIG. 10 represents the stage “Offer.” Actions performed in this stage pertain only to those candidates designated as in the stage Offer, according to their status in the project book.

In step 1005, a determination is made whether to extend an offer. If the determination is made to extend an offer, the method proceeds to step 1010, and the method proceeds as described hereinafter. If a determination is made that the offer is pending approval, the method proceeds to step 1015, and the method proceeds as described hereinafter. If the determination is made to that the offer is pending a background check, the method proceeds to step 1020, and the method proceeds as described hereinafter.

In step 1010, an offer for hire is extended to the candidate. In step 1025, the recruiter updates the stage and disposition of the candidate to reflect that an offer has been extended. In step 1030, the recruiter receives feedback from the candidate regarding the offer. Feedback can include an acceptance, declination, or further inquiries.

In step 1035, the recruiter updates the stage and disposition of the candidate, as described previously with reference to step 540 of FIG. 5. For example, if the candidate accepted the position, the recruiter would update the disposition to “Accepted.” The method then proceeds to step 325, as described in more detail hereinafter.

In step 1015, if the determination is made that the offer is pending approval, an offer is not extended at this time. More time is needed for the client to review the candidate. The method proceeds to step 1035, as described previously.

In step 1020, if the determination is made that the offer is pending approval, an offer is not extended at this time. More time is needed to receive the background check results. The method proceeds to step 1035, as described previously.

In step 325, the recruiter tracks the time spent in the offer stage, or in other words, the time spent performing steps 1005 through 1035. Step 325 will be described in more detail herein with reference to FIG. 12. The method proceeds to step 440 of FIG. 4.

FIG. 11 is a flow chart depicting a method 440 for hiring a candidate, in accordance with an exemplary embodiment of the present invention. The exemplary method 440 is illustrative and, in alternative embodiments of the invention, certain steps can be performed in a different order, in parallel with one another, or omitted entirely, and/or certain additional steps can be performed without departing from the scope and spirit of the invention. The method 440 is described hereinafter with reference to FIGS. 1, 4, and 12.

FIG. 11 represents the stage “Hire.” Actions performed in this stage pertain only to those candidates designated as in the stage Hire, according to their status in the project book. A

In step 1105, the client hires the candidate. In step 1110, the recruiter updates the candidate's disposition and stage in the project book, as described previously with reference to step 540 of FIG. 5.

In step 1115, the recruiter can wrap the project book as appropriate and/or as requested by the client. Wrapping the project book means to compile all of the information included in the project book into a file to be transferred to the client. For example, the project book can be wrapped in an excel file and/or a flat file

In step 325, the recruiter tracks the time spent in the offer stage, or in other words, the time spent performing steps 1005 through 1035. Step 325 will be described in more detail herein with reference to FIG. 12. The method proceeds to step 225 of FIG. 2.

FIG. 12 is a flow chart depicting a method 325 for tracking time, in accordance with an exemplary embodiment of the present invention. The exemplary method 325 is illustrative and, in alternative embodiments of the invention, certain steps can be performed in a different order, in parallel with one another, or omitted entirely, and/or certain additional steps can be performed without departing from the scope and spirit of the invention. The method 325 is described hereinafter with reference to FIG. 1.

In step 1205, a determination is made which timesheet function will be accessed. Access to the various functions is based on the particular type of recruitment personnel that logged on to the workstation 102. For example, a manager can perform the functions of creating, modifying, and viewing a timesheet and deleting a time entry, in addition to the numerous manager functions. The recruitment module 108 determines which functions are available to which users based on configuration settings. The user selects a function from available functions by inputting a selection into the workstation 102.

In response to a determination to create a timesheet, the method proceeds to step 1210. In step 1210, the workstation 102 displays an interface capable of receiving information to create a timesheet. For example, the workstation 102 can display a user interface comprising multiple fields into which the user can input the appropriate information to the recruitment module 108 for storage in the recruitment database 114. The user can create multiple entries in a timesheet during the current day using the workstation 102 over the network 104. Accordingly, reports, invoicing, and other metrics based on time have accurate and current information on a daily basis in the recruitment module 108.

In step 1235, the user creating the timesheet enters a client into the appropriate field displayed on the workstation 102. For example, the user can select the client from a drop down menu displayed on the workstation 102.

In step 1260, the user creating the timesheet enters the bill code into the appropriate field displayed on the workstation 102. Again, this can be accomplished by the user selecting the bill code from a drop down menu, or other input mechanism, displayed on the workstation 102. The bill code, as previously described herein, is particular to an individual client and the client's hiring request.

In step 1265, the user creating the timesheet enters the service type relating to the activity performed into the appropriate field displayed on the workstation 102. Service types are customizable to a particular client and/or bill code. The recruitment module 108 stores the service types particular to a client and/or bill code. Service types represent a particular activity within the recruitment process. In an exemplary embodiment, service types include: research, build itinerary, prequalify, and other steps in the recruitment project. An administrator can configure the recruitment module 108 with customized service types, as described herein with reference to FIG. 2. Table 2.0 below is a representative listing of service types, in accordance with an exemplary embodiment of the present invention. Under the column “Example,” the meaning of each service type is exemplified. The table below is merely representative of exemplary service types, and one of ordinary skill in the art would recognize that other service types can be used without departing from the spirit and scope of the invention.

TABLE 2.0

| Service Type Code | Description | Example |
|---|---|---|
| D—Determine | Determining Interest | This code will be used for determining |
| Interest | | interest of candidates in the public folder, |
| | | project book, post TTI, pre-prescreen. |
| I—Itinerary Building | Building Project Book | Building the project book with the |
| | | appropriate companies. |
| JF—Job Fair | Attendance at a Job | Attending a job fair |
| | Fair | |
| N—Internet | Internet Recruiting | Mining all internet sites |
| Recruiting | | |
| M—ATS Mining | ATS Mining | Mining appropriate ATS |
| R—Research | Researching Names | Researching names of potential prospect |
| | for the project book | candidates and entering them into the |
| | | project book |
| PR—Printing | Printing Paper | Printing paper applications for Hourly |
| Applications | Applications | Events |
| RR—Resume | Reviewing | Reviewing resumes of candidates that |
| Review (*) | candidates that have | applied in appropriate ATS, public folder or |
| | applied in ATS or | paper application |
| | Public Folder | |
| PS—Prescreen | Conduct prescreen | After determining that the candidate is |
| and/or Sched TTI (*) | with candidate. If IQ, | interested in the position the recruiter will |
| | schedule TTI. | conduct the prescreen |
| Q—Qualify | Conducting an | Recruiter will conduct targeted telephone |
| | interview | interview and determine if the candidate is |
| | | interested and qualified. |
| AP—Profiles | Create profile for | After qualifying a candidate during a |
| | interested and | targeted telephone interview, the recruiter |
| | qualified candidate to | will create a profile to be submitted to the |
| | submit to client, | client. Recruitment support will also use |
| | | this code when editing profiles. |
| G—Registration | Register qualified | After qualifying a candidate the forum |
| | candidate to attend | coordinator will contact the candidate to |
| | forum. | register them for the forum. |
| RS—Roster | Schedule qualified | After qualifying a candidate, the candidate |
| Scheduling | candidate to attend | is scheduled to an event or interview |
| | Hiring Event or | including date time and location. |
| | Interview | |
| C—Client Contact | Client follow-up, | Primarily used by managers as the code |
| | conversations, touch | used when having conversations with |
| | base, conference | active clients on projects |
| | calls with the external | |
| | client regarding | |
| | active projects | |
| W—Wrap | Preparing the final | Certain managers use this code when |
| | prospect itinerary | preparing the final prospect itinerary |
| | (project book) to | (project book) to submit to the client |
| | submit to the client | |
| X—Reference | This code is used | This code is used when performing a |
| Check | when performing a | reference check and/or background checks |
| | reference check | on candidates per the client. |
| | and/or background | |
| | checks on candidates | |
| | per the client | |
| A—Admin | This code is used by | Utilized for administrative tasks completed |
| | the Recruitment | for our client(s). |
| | Support and Media | |
| | Placement when | |
| | performing | |
| | administrative tasks | |
| P—Project | This code is primarily | Recruiters who use this code are |
| Management | used by individuals | performing management function such as |
| | performing a | project review or updates |
| | management | |
| | functions | |
| IP—Internet | This code is primarily | Most positions have to be posted externally |
| Posting/Media | used by individuals | for candidates to see and apply to; this |
| | posting and/or | code is when setting those posting up via |
| | researching positions | the intranet as well as the internet. |
| | on internet media | |
| | sites | |
| T—Training | This is the code | The recruiters are set appointments in |
| | primary used when | order to review and streamline any new |
| | training recruiters of | process or procedure. |
| | new processes or | |
| | techniques | |

In step 1270, the user creating a timesheet enters time, in minutes, spent performing the particular service type entered in step 1265 for the bill code entered in step 1235 into the appropriate field displayed on the workstation 102. The user can input the amount of time into the recruitment module 108 over the network 104 by accessing the workstation 102. Accordingly, the recruitment module 108 captures detailed information regarding the time spent throughout the recruitment process.

In step 1275, the user creating the timesheet can enter comments pertaining to the timesheet into the appropriate field displayed on the workstation 102. For example, the user can detail the precise activity related to their time.

In step 1295, the recruitment database 114 stores timesheet information input into the recruitment module 108 for current and/or past recruitment projects. An administrator can manage the frequency and content of the timesheet information stored in the recruitment database 114. In an exemplary embodiment, such information is stored in tables; however, one of ordinary skill in the art having the benefit of this disclosure would recognize that various storage techniques can be used without departing form the scope and spirit of the invention. The method then proceeds to step 215 of FIG. 2, as described previously herein.

Referring back to step 1205, in response to a determination to modify a timesheet, the method proceeds to step 1215. In step 1215, the workstation 102 displays an interface capable of modifying information in the timesheet for the current day.

In step 1240, the user can change the bill code, client, time, service type, and/or comments in a timesheet for the current day using the workstation 102 by entering the revised information into the appropriate field displayed on the workstation 102. The recruitment module 108 receives the changes over the network 104. The method then proceeds to step 1295, as described previously herein.

Referring back to step 1205, in response to a determination to view time, the method proceeds to step 1220. In step 1220, the workstation 102 displays an interface capable of displaying total time for the current day and/or previous days. The workstation 102 displays the information received from the recruitment module 108 via the network 104. In addition, the recruitment module 108 can access the recruitment database 114 to fulfill the request, if the request pertains to data stored in the recruitment database 114.

Referring back to step 1205, in step 1245, the user can select options to view the total time they have entered for the current day and/or previous days by selecting the appropriate field displayed on the workstation 102. For example, the user can view their total time for the previous week. This can be accomplished using a drop down menu, or entering data ranges on the workstation 102. The workstation 102 displays the requested information received from the recruitment module 108 over the network 104. In addition, the recruitment module 108 can access the recruitment database 114 to fulfill the request, if the request pertains to data stored in the recruitment database 114. The method then proceeds to step 1295, as described previously herein.

In response to a determination to delete an entry, the method proceeds to step 1225. In step 1225, the workstation 102 displays an interface capable of deleting a time entry for the current day.

In step 1250, the user can select a particular time entry from the current day for deletion by selecting the appropriate field or group of fields displayed on the workstation 102. Then, the workstation 102 communicates the command to delete the selected entry to the recruitment module 108 over the network 104 to delete the selected entry. The method then proceeds to step 1295, as described previously herein.

Referring back to step 1205, in response to a determination to perform manager functions, the method proceeds to step 1230. In step 1230, the workstation 102 displays an interface displaying the manager functions related to timesheets. A manager also has access to the other functions displayed in FIG. 12, but has the following additional functionality as well.

In step 1255, the manager can create, modify, and/or delete the timesheets of others. For example, if a recruiter fails to enter time for the current day, a manger can enter the time for that recruiter by accessing that user's data via the workstation 102. The workstation 102 can display the requested data by communicating with the recruitment module 108 over the network 104. In this way, the manager can ensure that the system reflects the most accurate and up to date information, for invoicing and payroll purposes.

In step 1280, the manager can adjust time by inputting information into the appropriate field displayed on the workstation 102. Adjusting time allows certain time to be put on hold so as not to be invoiced to a client. Again, this is accomplished when the manager accesses the workstation 102, which communicates with the recruitment module 108 to ensure the time is adjusted accordingly. The time may later be taken off hold and invoiced during a later time period.

In step 1285, the manager can close timesheets after invoicing. Closed timesheets prevent others from editing the timesheet. The manager closes the time using the workstation 102, which communicates with the recruitment module 108. In an exemplary embodiment, the recruitment module 108 can interface with internal human resources and financial systems 116. Accordingly, invoicing systems, can receive accurate timesheets from the recruitment module 108, for accurate and prompt invoicing.

In step 1290, the manager can close timesheets after payroll. By closing the timesheets, payroll can be generated. The manager closes the timesheets using the workstation 102, which communicates with the recruitment module 108. And, as stated above, the recruitment module 108 can interface with internal human resources and financial systems 116. Accordingly, an internal payroll system can receive accurate timesheets from the recruitment module 108, for generating accurate payroll. The method then proceeds to step 1295, as described previously herein.

FIG. 13 is a flow chart depicting a method for generating reports, in accordance with an exemplary embodiment of the present invention. The exemplary method 225 is illustrative and, in alternative embodiments of the invention, certain steps can be performed in a different order, in parallel with one another, or omitted entirely, and/or certain additional steps can be performed without departing from the scope and spirit of the invention. The method 225 is described hereinafter with reference to FIGS. 1 and 2.

In an exemplary embodiment, the user selects a report type using the workstation 102, which communicates with the recruitment module 108. The recruitment module 108 stores (either in internal memory or the database 114) the routines for generating reports based on the information input into the recruitment module 108 and stored in the database 114. The recruitment module 108 can receive an instruction to execute a routine, retrieve the data necessary for the routine, perform the requested functionality, and output a result of the routine for display on the workstation 102.

In step 1305, a determination is made as to the type of report to generate by receiving a user request for a particular report input via the workstation 102. Reports can include a variety of data in a variety of formats. In an exemplary embodiment, reports can include a billing worksheet, a candidate flow, a snapshot of the candidates in the project book, a project book report, and a weekly productivity report. Provided herein are just a few examples of the many available types and reports, and one of ordinary skill in the art would recognize that other reports can be made from the available data without departing from the spirit and scope of the invention. In step 1310, the user generating the report selects the appropriate criteria for the report by inputting information into the appropriate field displayed on the workstation 102. Criteria can include a particular time period, project (bill code), client, recruiter, or other suitable criteria. For example, a report can be generated based on a particular week for a particular project. This selection can be accomplished, for example, by making selections in drop down menus, calendars, text boxes, and the like on the workstation 102.

In step 1315, the recruitment module 108 generates the report for display on the workstation 102 based on the selected type of report and input criteria. The recruitment module 108 communicates with the workstation 102 to receive the user's request as it pertains to the type of report and criteria. In addition, the report can be printed, emailed, and/or saved to a hard drive. In generating the report, the recruitment module 108 can access information stored within the recruitment module 108, and/or data stored in the recruitment database 114. The recruitment database 114 is available for storing current and/or archived information related to the recruitment process. The method then proceeds to step 230 of FIG. 2.

FIG. 14 is a screenshot depicting a representative user interface display of a report 1400, in accordance with an exemplary embodiment of the present invention. As shown in FIG. 14, the representative report shows a snapshot of the current status of three different recruitment projects. The columns shown in row 1405 indicate the status metrics for a particular project. Column 1410, entitled “Src/TBC” represents the number of candidates that are in the sourcing stage, which is used herein to refer to the build project book stage, and having a disposition of “TBC,” meaning “to be contacted.” Column 1415, entitled “Src/Inbox,” represents the number of candidates in the sourcing stage and having a disposition of “Inbox,” indicating the candidate has completed a questionnaire. Column 1420, entitled “PQ/LM,” represents the number of candidates in the prequalification stage having a disposition of “LM,” indicating the recruiter has called or emailed the candidate. Column 1425, entitled “PQ/BOLO,” represents the number of candidates in the prequalification stage having a disposition of “BOLO,” meaning “be on the lookout for.” Column 1430, entitled “Qual/TTI,” represents the number of candidates in the qualification stage having a disposition of “TTI,” meaning the targeted telephone interview is scheduled. Column 1435, entitled “MR/Pend” represents the number of candidates in the manager review stage having a disposition of “pending.” Column 1440, entitled “IQ,” represents the number of interested and qualified candidates presented to the client (IQs). Thus, this exemplary report provides a current snapshot of the client's project, indicating where candidates stand in the recruitment process, and the relationship of the overall status to the client's goal. The recruitment module 108 can calculate the results for each of the metrics based on information stored in the recruitment module 108 and/or the recruitment database 114. Other metrics contained in FIG. 14 are described hereinafter with reference to Table 3.0.

In addition, FIG. 14 indicates the metric 1445 entitled “Hrs/IQ,” as described previously. This metric equals the total number of hours spent by the recruiters working on a particular recruitment project, shown in FIG. 14 as element 1480, divided by the total number of candidates that are interested and qualified (“IQs”), shown in FIG. 14 as element 1440, and thus presented to the client for consideration and interviewing. As the ultimate goal in a recruitment project is to present interested and qualified candidates to the client for eventual hiring, “Hrs/IQ” provides an important indication of the time it will take, and the cost required, to meet the client's goal. The “Hrs/IQ” metric can be leveraged for future projects having similar features, such as a similar job title, similar client type, or other similarity basis. Based on the “Hrs/IQ” metric, a manager can predict the number of recruiter hours that are likely to be necessary for a particular project. In this way, a manager can plan a project accordingly, by electing the optimal number of recruiters for the project over the life of the project. For example, the manager can plan for a certain level of recruiters when the candidates are in the early stages of the recruitment process, such as prequalification, and then scale down the number of recruiters as the candidates advances in stages, based on the historical data captured from previous, similar projects. This use of historical data additionally leads to client satisfaction, as the client is provided a realistic forecast of the timeline and budget for a recruitment project.

For example, a recruitment project may have 15 open positions. In order to fill the 15 positions, the client may need, for example, to interview 25 IQs. The relationship between positions to be filled and the number of IQs required to be interviewed can vary based on client, job type, and other factors. In this example, if the “Hrs/IQ” for a similar project is equal to 10, the total number of recruiting hours for this project would be forecasted to be 10 hours multiplied by 25 IQs, equaling 250 total hours. Accordingly, a manager can provide the client with a budget and timeline based on 250 total number of hours required for the project. In addition, the total number of hours can be divided among a certain number of recruiters. Thus, the project can be appropriately staffed based on the “Hrs/IQ” metric. Further, based on historical data of the candidate flow through the various stages, described herein with reference to column 1405 of FIG. 4, the project can be staffed with different levels of recruiters at different stages, and the client can be provided with a timeline for completion of the project. As noted above, this is merely one example of the many available types of available metrics, and one of ordinary skill in the art having the benefit of this disclosure would recognize that other reports can be made without departing from the spirit and scope of the invention.

Table 3.0 below depicts a representative set of metrics, capable of being determined and reported by the recruitment module 108, in accordance with an exemplary embodiment of the present invention. Under the column “Description,” the meaning of each metric is described. The table below is merely representative of exemplary metrics, and one of ordinary skill in the art having the benefit of this disclosure would recognize that other stages and dispositions can be used without departing from the spirit and scope of the invention.

TABLE 3.0

| Figure | | |
|---|---|---|
| Number | Metric | Description |
| 1450 | Roster to Goal | The number of people on the roster, or |
| | | project book, compared to the goal number |
| | | of Interested and Qualified candidates |
| | | presented to the client (“IQs”). This tells the |
| | | client how close they are to completing the |
| | | roster. |
| | | Roster Count/Client Goal |
| 1455 | Days Elapsed | How many business days have elapsed since |
| | | the client started recruiting. |
| | | Count the number of business days less |
| | | holidays from the recruiting start date until |
| | | the current system date. |
| 1460 | Total Hours vs. | This calculation tells the client how many |
| | Budget | hours they have billed currently compared to |
| | | how many they have budgeted for the |
| | | project. |
| | | Total Hours billed to a project divided by the |
| | | standard hours per IQ multiplied by the |
| | | client goal. |
| 1465 | Previous Day IQs | This is the count of IQs for a project for the |
| | | previous business day. |
| | | How many IQs were captured for a bill code |
| | | as of the prior business day. |
| 1470 | Previous Day | This is the sum of billed hours to a project |
| | hours | up to the previous business day. |
| | | The sum of the billed hours for a bill code as |
| | | of the previous business day. |
| 1475 | Previous Day | This calculation tells the client how many |
| | Hours per IQ | hours per IQ they had on the previous |
| | | business day. |
| | | Previous days billed hours divided by the |
| | | previous days IQs. |
| 1440 | IQs | The number of IQs identified for the project. |
| | | The sum of the IQs set for each requisition |
| | | for a particular bill code. |
| 1480 | Total Hours | The number of hours that have currently |
| | Billable | been billed to the project. |
| | | The sum of all the minutes billed for a bill |
| | | code divided by 60 to convert to hours. |
| 1445 | Hours per IQ | The number of hours billed to a project |
| | | divided by the number of IQs identified for |
| | | the project. |
| | | Total hours billed/Current number of IQs |
| 1485 | Hours per Roster | How many hours per IQ on the roster |
| | | compared to the total billable hours. |
| | | Total hours billed/Roster Count/Standard |
| | | hours per IQ |
| 1490 | Standard Hours/ | How many hours per IQ compared to the |
| | IQ | budget. |
| | | Total hours billed/IQs/Standard Hours Per |
| | | IQ |
| 1495 | Client Goal | How many candidates are expected to obtain |
| | | the desired number of hires for a client and |
| | | position. |
| | | If the sum of the requisitions goal counts is |
| | | greater than zero then client goal equals the |
| | | sum, otherwise the client goal is the |
| | | candidate needed count stored with the bill |
| | | code. |

The above metrics can provide valuable insight into the recruitment process. The metrics can provide an accurate snapshot for a current project, and such data eventually constitutes historical data that can be used to plan future projects. Such insight can lead to cost savings, more accurate budgeting and forecasting, client satisfaction at knowing and understanding the status of a recruitment project, benchmarking, and accurate invoicing and payroll. Although specific embodiments of the invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by a person having ordinary skill in the art without departing from the spirit and scope of the invention defined in the following claims, the scope of which is to be accorded the broadest interpretation so as to encompass such modifications and equivalent structures.

What is claimed:

1. A method for analytical recruitment, comprising the steps of:
tracking a disposition of each of a plurality of candidates at each of a plurality of stages in a recruitment process;
recording an amount of time spent by a plurality of recruiters performing a plurality of recruitment activities at each of the stages of the recruitment process;
storing amounts of time representing each amount of time spent by a plurality of recruiters performing each of a plurality of recruitment activities for each of the candidates at each of the stages of the recruitment process;
calculating a metric equal to a total amount of stored time divided by a total number of candidates presented to a hiring entity; and
displaying a result of the metric calculated in the calucating step.

2. The method of claim 1, wherein the plurality of stages of the recruitment process comprises at least two of building a project book of candidates, pre-qualifying a candidate, qualifying a candidate, conducting a manager review of a candidate, interviewing a candidate, extending an offer for hire to a candidate, and hiring a candidate.

3. The method according to claim 1, wherein the disposition corresponds to a status of the candidate associated with at least one of the candidate's progress in the recruitment process, the candidate's interest, the candidate's qualification, the candidate's availability, a client's review of the candidate, and a recruiter's review of the candidate.

4. The method according to claim 1, wherein the recording step further comprises recording a service type corresponding to the plurality of recruitment activities.

5. The method according to claim 4, wherein the service type is customizable to a client.

6. The method according to claim 4, wherein the service type comprises at least one of researching, determining interest, qualifying, interviewing, and scheduling.

7. The method according to claim 1, wherein the total number of candidates presented to the hiring entity comprises a total number of candidates that are interested and qualified in a hiring request from the hiring entity.

8. The method according to claim 1, wherein the displaying step further comprises displaying a current depiction of a status of a hiring request from a hiring entity as compared to a goal.

9. The method according to claim 8, wherein the current depiction of the status of the hiring request from the hiring entity is based on current data from the current day.

10. A system for analytical recruitment comprising:
a recruitment module configured to store and update information associated with a plurality of candidates, the recruitment module being further configured to calculate a plurality of metrics based on a plurality of time entries and the information associated with the plurality of candidates;
a workstation, logically connected to the recruitment module, and configured to display information associated with the plurality of candidates, the workstation being further configured to receive updates to the information associated with the plurality of candidates, and to receive the plurality of time entries;
a recruitment database, logically connected to the recruitment module, and configured to store the plurality of time entries, the information associated with the plurality of candidates, and the metrics.

11. The system of claim 10, wherein the information associated with the plurality of candidates comprises a stage and a disposition associated with each of the plurality of candidates.

12. The system of claim 11, wherein the stage associated with each of the plurality of candidates comprises a sequential part of the recruitment process.

13. The system according to claim 11, wherein the disposition associated with each of the plurality of candidates comprises at least one of represents a status of the candidate at each of the stages.

14. The system according to claim 10, wherein each of the plurality of time entries comprises: an amount of time spent by a recruiter performing each of a plurality of recruitment activities associated with each stage of a candidate, an associated project, and a service type corresponding to the plurality of recruitment activities.

15. The system according to claim 14, wherein the associated project indicates a particular hiring request from a particular hiring entity.

16. The system according to claim 14, wherein the service type corresponding to the plurality of recruitment activities is customizable to a client.

17. The system according to claim 10, wherein the recruitment module is further configured to generate a plurality of reports comprising one or more charts, graphs, and tables associated with the amount of time spent performing a plurality of recruitment activities at each of the plurality of stages of the recruitment process, for use in invoicing, sales, benchmarking, status reporting, and forecasting, further comprises providing a current depiction of the status of the hiring request from the hiring entity.

18. The system according to claim 17, wherein the current depiction of the status of the hiring request from the hiring entity is based on data from the current as of the same day or the previous day.

19. The system according to claim 10, wherein the plurality of metrics based on the plurality of time entries and the information associated with the plurality of candidates comprises the total time entries for an associated recruitment project divided by the total number of candidates presented to the hiring entity of the associated recruitment project.

20. The system according to claim 19, wherein the total number of candidates presented to the hiring entity comprises the total number of candidates that are interested and qualified in the hiring request from the hiring entity.

21. The system according to claim 19, wherein the metric of the total time entries for an associated recruitment project divided by the total number of candidates presented to the hiring entity of the associated recruitment project is useful in predicting a number of recruiters for a future project.

22. The system according to claim 19, wherein the metric of the total time entries for an associated recruitment project divided by the total number of candidates presented to the hiring entity of the associated recruitment project is useful in predicting a budget for a future project.

23. A method for analytical recruitment, comprising the steps of:
tracking a candidate during a recruitment process;
recording an amount of time spent by a plurality of recruiters performing a plurality of recruitment activities during the recruitment process;
calculating one or more metrics associated with the amount of time spent by the plurality of recruiters performing the plurality of recruitment activities during the recruitment process;
predicting a resource level for a recruitment project based on the one or more metrics associated with the amount of time spent performing a plurality of recruitment activities at each of the plurality of stages of the recruitment process.

24. The method according to claim 23, wherein the step of tracking a candidate during the recruitment process further comprises tracking a plurality of stages of the candidate.

25. The method according to claim 24, wherein the plurality of stages comprise chronological parts of the recruitment process.

26. The method according to claim 24, wherein the chronological parts of the recruitment process comprise: building a project book of candidates, pre-qualifying a candidate, qualifying a candidate, conducting a manager review of a candidate, interviewing a candidate, extending an offer for hire to a candidate, and hiring a candidate.

27. The method according to claim 23, wherein the step of tracking a candidate during the recruitment process further comprises tracking a plurality of dispositions of the candidate.

28. The method according to claim 27, wherein the plurality of dispositions of the candidate correspond to a status of the candidate.

29. The method according to claim 28, wherein the status of the candidate is associated with at least one of: the candidate's progress in the recruitment process; the candidate's interest, the candidate's qualification, the candidate's availability, a client's review of the candidate; and a recruiter's review of the candidate.

30. The method according to claim 23, wherein the step of recording an amount of time spent by a recruiter performing a plurality of recruitment activities during the recruitment process further comprises recording a service type corresponding to the plurality of recruitment activities.

31. The method according to claim 30, wherein the service type corresponding to the plurality of recruitment activities is customizable to a client.

32. The method according to claim 23, wherein the step of recording an amount of time spent by a plurality of recruiters performing a plurality of recruitment activities at each of the plurality of stages of the recruitment process occurs daily, such that the amount of time spent each day is recorded on the same day.

33. The method according to claim 23, wherein the one or more metrics comprises a total time spent in relation to a recruitment project, divided by the number of candidates at a particular stage in the recruitment process.

34. The method according to claim 33, wherein the particular stage in the recruitment process comprises presenting a candidate to the client.

35. The method according to claim 23, wherein the predicting step further comprises predicting a budget for a future recruitment project based on the total time spent in relation to a prior recruitment project, divided by the total number of candidates presented to the client in relation to the prior recruitment project.

36. The method according to claim 23, wherein the predicting step further comprises predicting a timeline for completion of a future recruitment project based on the total time spent in relation to a prior recruitment project.
